(19) United States
(12) Patent Application Publication
(10) Pub. No.: US 2017/0364516 A1
(43) Pub. Date: Dec. 21, 2017

(54) LINGUISTIC MODEL SELECTION FOR ADAPTIVE AUTOMATIC SPEECH RECOGNITION

(71) Applicant: Intel Corporation

(72) Inventors: Eric Ariel Shellef, Mountain View, CA (US); Reshef Shilon, Palo Alto, CA (US); Peter Graff, San Jose, CA (US); Jonathan Eng, Saratoga, CA (US); Guillermo Perez, Sevilla (ES); Juan Manuel Lucas, Sevilla (ES); Martin Henk Van Den Berg, Palo Alto, CA (US)

(73) Assignee: Intel Corporation, Santa Clara, CA (US)

(21) Appl. No.: 15/129,590

(22) PCT Filed: Dec. 24, 2015
(86) PCT No.: PCT/EP2015/081243

§ 371 Date: Sep. 27, 2016

(51) Int. Cl. G06F 17/30; G10L 15/183; G10L 15/07; G10L 17/22; G10L 17/02; G06K 9/00

(52) U.S. Cl. CPC G06F 17/30032; G10L 17/22; G10L 17/02; G10L 15/183; G10L 15/075; G06K 2009/00939

(57) ABSTRACT

The present disclosure describes dynamically adjusting linguistic models for automatic speech recognition based on biometric information to produce a more reliable speech recognition experience. Embodiments include receiving a speech signal, receiving a biometric signal from a biometric sensor implemented at least partially in hardware, determining a linguistic model based on the biometric signal, and processing the speech signal for speech recognition using the linguistic model based on the biometric signal.

### TECHNICAL FIELD

This disclosure pertains to dynamically selecting a linguistic model for automatic speech recognition, and more particularly, to dynamically selecting acoustic and language models for adaptive automatic speech recognition using biometric information.

### BACKGROUND

Automatic speech recognition (ASR) systems help natural language interfaces recognize human speech and turn it into text that can be processed further. ASR systems rely on linguistic models (e.g., acoustic models, language models, phonetic dictionaries, etc.) to achieve this. Current ASR systems use specific linguistic models that are not adaptive to the user or the environment in which the input is fed into the system.

### BRIEF DESCRIPTION OF THE DRAWINGS

FIG. 1 is a schematic block diagram of a system that includes an adaptive automatic speech recognition system in accordance with embodiments of the present disclosure.

FIG. 2 is a schematic block diagram of an adaptive automatic speech recognition system in accordance with embodiments of the present disclosure.

FIG. 3 is a schematic block diagram of a dialog system that uses an adaptive automatic speech recognition system in accordance with embodiments of the present disclosure.

FIG. 4 is a process flow diagram for selecting a linguistic model for automatic speech recognition in accordance with embodiments of the present disclosure.

FIG. 5 is a process flow diagram for selecting a linguistic model for automatic speech recognition based on a heartrate input in accordance with embodiments of the present disclosure.

FIG. 6 is a process flow diagram for selecting a parser model and intent classifier model in accordance with embodiments of the present disclosure.

FIG. 7 is an example illustration of a processor according to an embodiment of the present disclosure.

FIG. 8 is a schematic block diagram of a mobile device in accordance with embodiments of the present disclosure.

FIG. 9 is a schematic block diagram of a computing system according to an embodiment of the present disclosure.

FIG. 10 is a process flow diagram for training an acoustic model for biometric input-based speech recognition.

### DETAILED DESCRIPTION

This disclosure describes an adaptive automatic speech recognition (ASR) system that dynamically changes linguistic models for ASR based on input from biometric sensors, as well as other contextual cues. Example contextual cues include user data (demographic, gender, acoustic properties of the voice such as pitch range), environmental factors (noise level, GPS location), communication success as measured based on dialog system performance/user experience given certain models). The use of targeted linguistic libraries results in a more accurate ASR experience. For example, exhaustion is known to modulate a speaker's voice, and a linguistic model trained on only exhausted speech may do better for an exhausted user than a more generic linguistic model.

This disclosure describes using the specific acoustic input received, preceding discourse, user exhaustion, the current state of the application, and input from biometric sensors to learn the specific circumstances under which the application is used. Sensors can, for example, note background noise to go to a more interference robust set of linguistic models. Biometric sensors, such as heart rate monitors, may cause the application to switch between at least two linguistic models, for example, such as one trained on fatigued and another trained on rested voices. Based on that, the system may process user input in different ways (e.g., switch to different automatic speech recognition models, dialog rules and classifiers, syntactic parsers or other natural language understanding tools). Examples include (1) allowing for more pauses between words, or, if an utterance isn't recognized, wait for more speech and combine the result with the previous utterance and try again; (2) switching to a different “tired voice” ASR model if the biometric data suggests that that might be needed; and (3) switching to a different parser, allowing for sloppier (more phonologically reduced) English when the user is tired and leaves out words (“what heart-rate” instead of “what is my heart-rate”) or uses ungrammatical utterances (“How drive to Palo Alto” instead of “How do I drive to Palo Alto”).

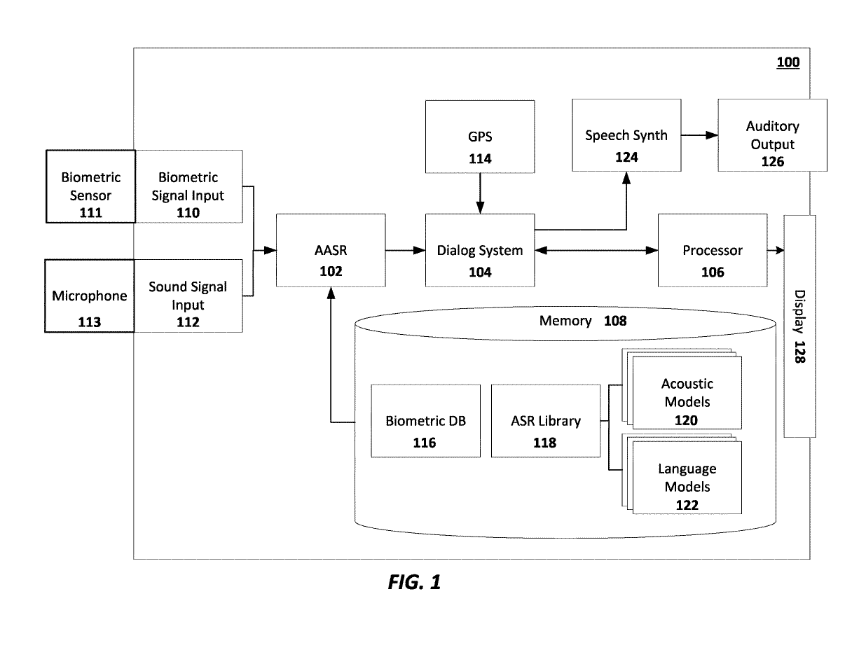

FIG. 1 is a schematic block diagram of a system 100 that includes an adaptive automatic speech recognition system in accordance with embodiments of the present disclosure. The system 100 includes an adaptive automatic speech recognition (AASR) module 102 that can be implemented in hardware, software, or a combination of hardware and software. The AASR module 102 can be communicably coupled to and receive input from a sound input 112 and a biometric input 110. The AASR module 102 can output recognized text to a dialog system 104.

Generally speaking, the dialog system 104 can receive textual inputs from the AASR module 102 to interpret the speech input and provide an appropriate response, in the form of an executed command, a verbal response (oral or textual), or some combination of the two. The system 100 also includes a processor 106 for executing instructions from the dialog system 104. The system 100 can also include a speech synthesizer 124 that can synthesize a voice output from the textual speech. And an auditory output 126 that outputs audible sounds, including synthesized voice sounds, via speaker or headphones or Bluetooth connected device, etc. The system 100 also includes a display 128 that can display textual information as part of a dialog, as a response to an instruction or inquiry, or for other reasons.

In some embodiments, system 100 also includes a GPS system 114 configured to provide location information to system 100. In some embodiments, the GPS system 114 can input location information into the dialog system 104 so that the dialog system 104 can use the location information for contextual interpretation of speech text received from the AASR module 102.

System 100 can include a memory 108. Memory 108 can include a hard drive, solid state drive, flash memory, or other type of storage unit or device. Memory 108 can store data, such as biometric database 116 and linguistic library 118. Biometric database 116 can store personalized biometric information that the AASR module 102 can use as a baseline or as a threshold to compare against biometric signals received from the biometric sensor 111. Based on the comparison between received biometric signals and the baseline or threshold biometric information stored in biometric database 116, the AASR module can select a linguistic model appropriate for the context derived from the biometric comparison. The linguistic model can include one or both of an acoustic model 120 or a language model 122, both of which can be stored in the linguistic library 118.

In some embodiments, the AASR can use machine learning and/or neural networks to be trained and to learn how to select a linguistic model.

In general terms, an acoustic model can model a relationship between a received audio signal and phonetic units in the language. A language model is responsible for modeling the phonetic unit sequences in the language.

The biometric sensor 111 can include any type of sensor that can receive a biometric signal from a user and convert that signal into an electronic signal. An example of a biometric sensor 111 includes a heartbeat sensor. Another example is a pulse oximeter, EEG, sweat sensor, breath rate sensor, pedometer, etc. In some embodiments, the biometric sensor 111 can include an inertial sensor to detect vibrations of the user, such as whether the users hands are shaking, etc. The biometric sensor 111 can convert biometric signals into corresponding electrical signals and input the biometric electrical signals to the AASR module 102 via a biometric input.

Other examples of biometric information can include heart rate, stride rate, cadence, breath rate, vocal fry, breathy phonation, amount of sweat, EEG data, etc.

The system 100 can also include a microphone 113 for converting audible sound into corresponding electrical sound signals. The sound signals are provided to the AASR module 102 via a sound signal input 112.

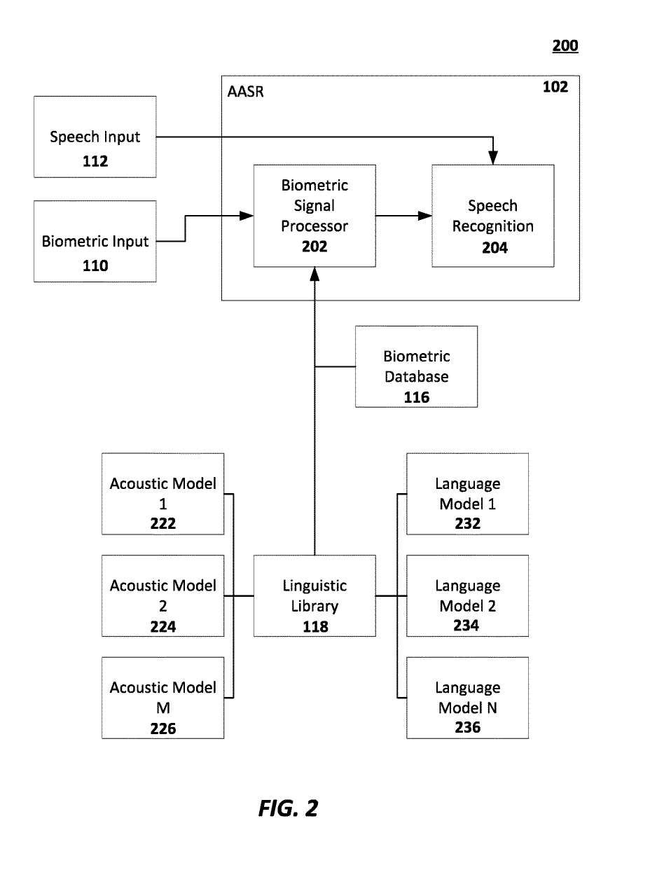

FIG. 2 is a schematic block diagram 200 of an adaptive automatic speech recognition (AASR) system 102 in accordance with embodiments of the present disclosure. The AASR system 102 can be a stand-alone device, a part of a wearable unit, or part of a larger system. The AASR system 102 can be implemented hardware, software, or a combination of hardware and software.

The AASR system 102 can include an adaptive automatic speech recognition module 102 implemented in hardware, software, or a combination of hardware and software. The AASR module 200 can include a biometric signal processor 202 and a speech recognition module 204. The biometric signal processor 202 can receive an electrical signal representing a biometric signal from a biometric input 110 (which is communicably coupled to a biometric sensor, as shown in FIG. 1).

The biometric signal processor 202 can process the biometric input 110 to identify a linguistic model that compensates for a potential change in the speaker's speech patterns, tones, syntax, distortion, diction, etc. that may occur when the speaker's biometric parameters is different form the normal or baseline biometric values associated with that user or with the population in general. For example, a heightened heartrate may cause the biometric signal processor 202 to select a linguistic model that compensates for changes in speech patterns associated with heightened heartrates. Such speech patterns include increased breathy phonation, exaggerated phonetic lengthening, more frequent pauses, more pauses within constituents (in unlikely linguistic contexts), strong breathing, frequent breathing noises, etc.

The biometric signal processor 202 can access a biometric information database 116 (or biometric database 116 for short). The biometric database 116 can store biometric information 210. Biometric information 210 can include user-defined biometric norms or thresholds or baselines that can be used by the biometric signal processor 202 to determine how to select a linguistic model. For example, a user can program the biometric database 116 with biometric information 210 such as resting heartrate, normal pulse-ox value, etc. The biometric signal processor 202 can receive a biometric signal from a biometric input 110. The biometric signal processor 202 can compare the biometric signal with corresponding biometric information 210 stored in the biometric database 116. The biometric signal processor 202 can then select a linguistic model based on the comparison between the received biometric signal and the stored biometric information.

Specifically, the biometric signal processor 202 can access a linguistic library 118. Linguistic library 118 can store a plurality of acoustic models, such as acoustic model 1 222, acoustic model 2 224, . . . acoustic model M 226, etc. The biometric signal processor 202 can select from among the various acoustic models depending on the biometric input signal received. Similarly, the linguistic library 118 can store a plurality of language models, such as language model 1 222, language model 2 224, . . . language model N 226, etc. The biometric signal processor 202 can select from among the various language models depending on the biometric input signal received, and in some cases, the biometric signal processor 202 can filter the language models based on a selected acoustic mode (and vice versa).

The AASR system 102 can include a speech recognition module 204 for converting received speech input signals into a computer-readable format, such as a textual format. The AASR system 102 can also include a speech input 112 (which is communicably coupled to a microphone or other audio input device). The speech recognition module 204 can receive an electrical signal representing speech from speech input 112. The speech recognition module 204 can use the selected linguistic model (i.e., the selected acoustic model and selected language model) from the biometric signal processor 202 to process the received speech signal to convert the speech signal into the computer readable format.

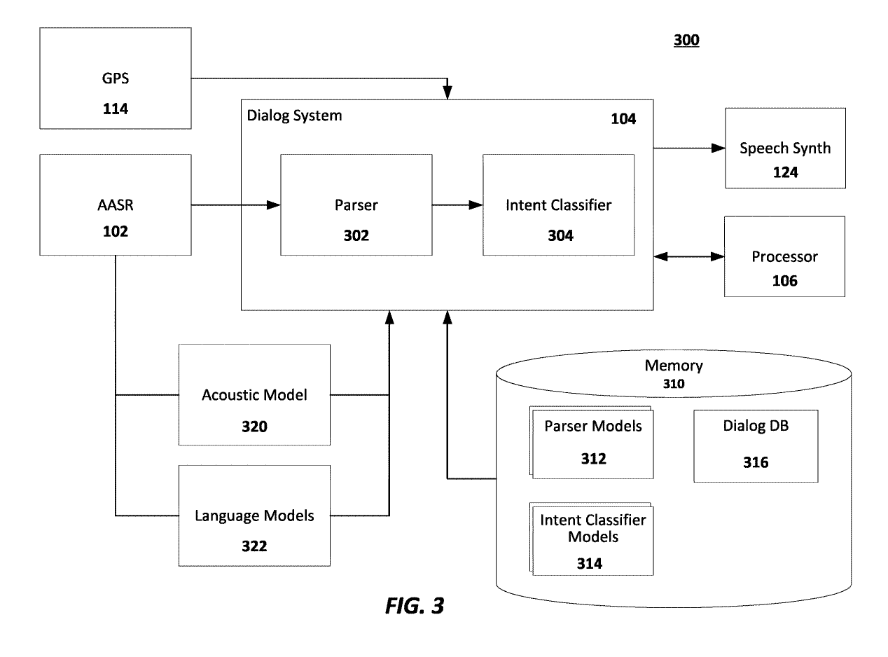

FIG. 3 is a schematic block diagram 300 of a dialog system 104 that uses an adaptive automatic speech recognition (AASR) system 102 in accordance with embodiments of the present disclosure. The AASR system 102 can provide a processed speech signal to the dialog system 104 in the form of a computer readable format, such as a text format. The dialog system 104 can process the received textual speech signal to determine the intent of the speaker and to engage in a conversation with the user to clarify the user's intent if the dialog system cannot determine the intent of the user. Additionally, the dialog system can provide feedback to the user based on a determined intent, such as verbally (i.e., orally, textually, etc.) answering a request or answering a question.

The dialog system 104 can include a parser module 302 implemented in hardware, software, or a combination of hardware and software. Parser module 302 is configured to receive the textual speech signal from the AASR system 102. The parser module 302 is configured to assemble a cohesive set of words, such as a sentence, sentence fragment, etc. from the received textual speech signal. The parser module 302 can then provide the cohesive set of words to an intent classifier module 304 implemented in hardware, software, or a combination. The intent classifier module 304 can determine an intent of the speaker. The intent classifier 304 can access a dialog database 316 stored in memory 310. The dialog database 304 can store relational information that connects a cohesive set of words to an instruction (e.g., instruction that causes a device to do something) or a response (e.g., answer to a question) or both (e.g., execute an instruction and provide a response). The dialog system 104 can then output an instruction to the processor 106 that can execute the instruction. The processor 106 can also provide an input back to the dialog system 104, which can use the input to configure a confirmation message or response, based on the determined intent of the speaker. The dialog system 104 can also output a signal to a speech synthesizer 124 that synthesizes an audible voice to provide the speaker (and others in ear-shot of the speaker) a response to the user's speech signal.

In some embodiments, the dialog system 104 can select a parser model from a plurality of parser models 312 stored in memory 310. The dialog system 104 can select the parser model based on the selected acoustic model 320 and/or the selected language model 322. Similarly, the dialog system 104 can select an intent classifier model from a plurality of intent classifier models 314 stored in memory 310 based on the selected acoustic model 320 and/or the selected language model 322.

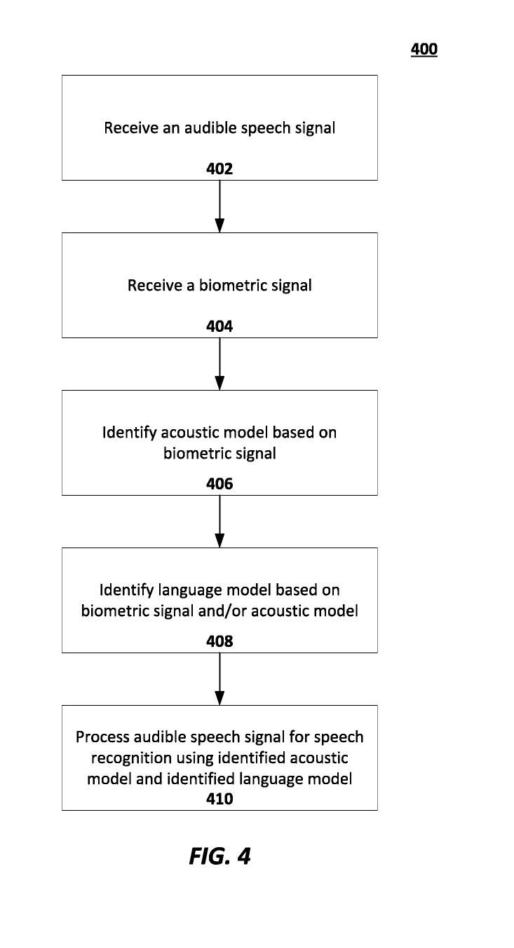

FIG. 4 is a process flow diagram 400 for selecting a linguistic model for automatic speech recognition (ASR) in accordance with embodiments of the present disclosure. An adaptive ASR system can receive an audible speech signal (i.e., an electrical signal representative of an audible speech signal) (402). The adaptive ASR system can also receive a biometric signal (404). The adaptive ASR system can determine an acoustic model based on the biometric signal (406). The adaptive ASR system can determine a language model based on the biometric signal (408). In some implementations, the language model can be determined based on both the biometric signal and the selected acoustic model. In some implementations, the language model can be determined based on the selected acoustic model. The adaptive ASR system can process the audible speech signal for speech recognition using the identified acoustic model and identified language model.

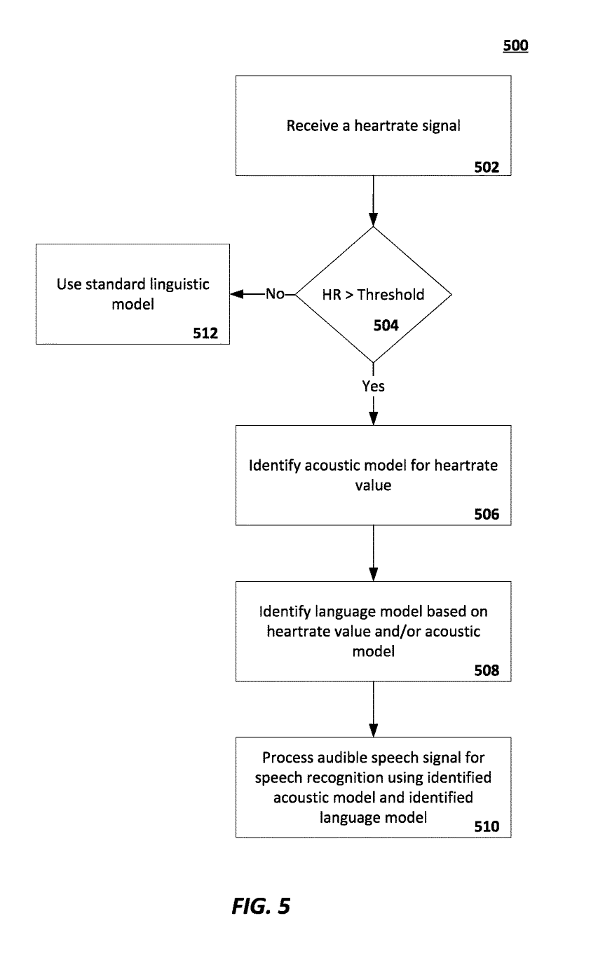

FIG. 5 is a process flow diagram 500 for selecting a linguistic model for automatic speech recognition based on a heartrate input in accordance with embodiments of the present disclosure. FIG. 5 provides one example implementation for selecting a linguistic model for speech recognition based on a biometric signal—in this case a heartrate. The adaptive ASR system can receive a heartrate signal (502) from, e.g., a heartrate monitor. The adaptive ASR system can compare the received heartrate signal with a threshold value (504). The threshold value can be defined by the user by, e.g., by entering into the system a resting heartrate. The threshold value can also be identified based on an average resting heartrate for people in the user's age group, weight, height, etc. Multiple threshold values can also be used. For example, a first threshold can represent a resting heartrate, which is associated with a first linguistic model. A second threshold value can represent a heartrate associated with a second linguistic model. Table 1 provides an example relational table for associating heartrate values with linguistic models:

TABLE 1

| Heartrate | Acoustic Model | Language Model |
|---|---|---|
| H ≦ H1 | Acoustic Model X | Language Model A |
| H2 ≧ H > H1 | Acoustic Model Y | Language Model B |
| H ≧ H2 | Acoustic Model Z | Language Model C |

For a heartrate less than or equal to a first threshold value, the adaptive ASR system can use a first linguistic model (such as a standard linguistic model) (512). For a heartrate greater than a threshold, the adaptive ASR system can identify an acoustic model associated with that heartrate (506). For a heartrate greater than a threshold, the adaptive ASR system can identify a language model associated with that heartrate (508). In some cases, the language model can be based on the selected acoustic model or both the heartrate and the acoustic model. The adaptive ASR system can process an audible speech signal for speech recognition using the identified acoustic model and identified language model.

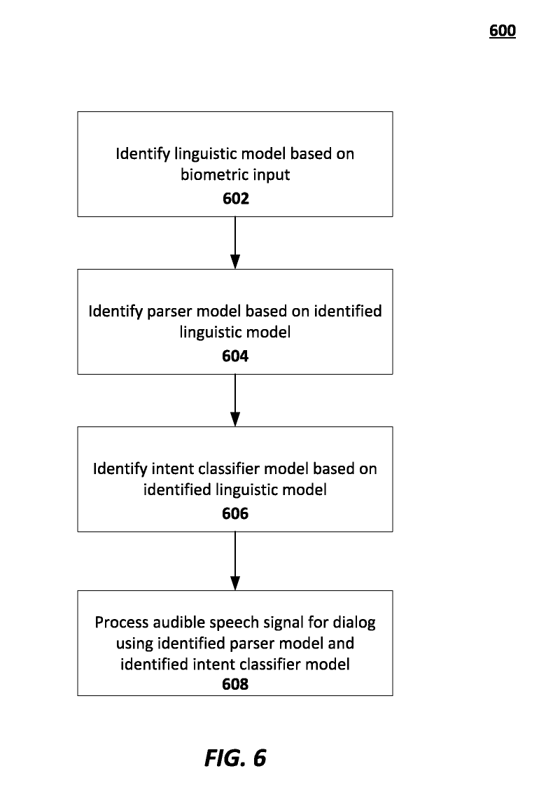

FIG. 6 is a process flow diagram 600 for selecting a parser model and intent classifier model in accordance with embodiments of the present disclosure. The dialog system can receive an identification of a linguistic model from an adaptive ASR system (602). The dialog system can identify a parser model based on the identified linguistic model (604). The dialog system can identify an intent classifier based on the identified linguistic model or both the identified linguistic model and the identified parser model. The dialog system can process an audible speech signal for dialog using the identified parser model and the identified intent classifier model.

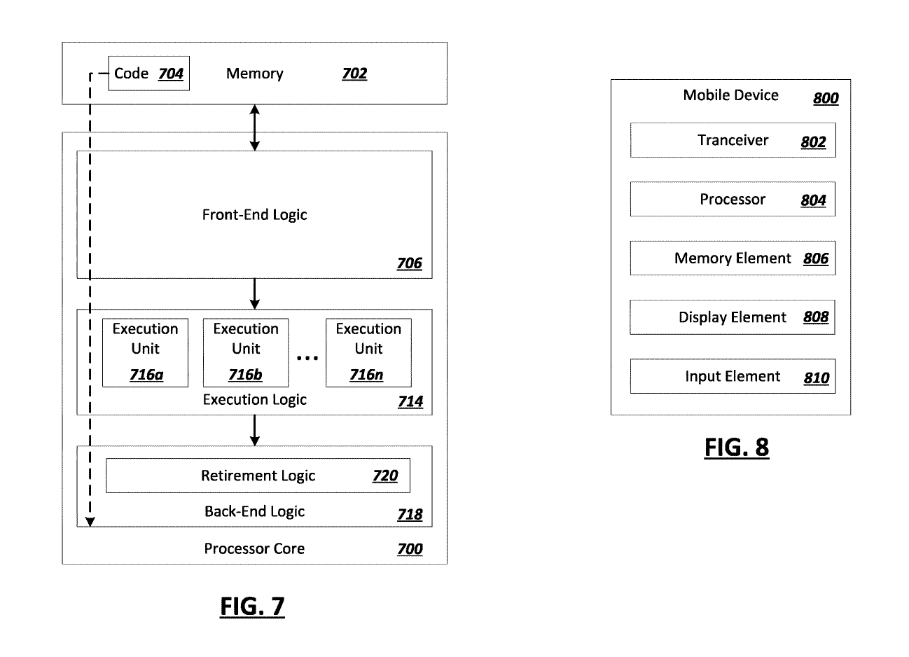

FIGS. 7-9 are block diagrams of exemplary computer architectures that may be used in accordance with embodiments disclosed herein. Other computer architecture designs known in the art for processors, mobile devices, and computing systems may also be used. Generally, suitable computer architectures for embodiments disclosed herein can include, but are not limited to, configurations illustrated in FIGS. 7-9.

FIG. 7 is an example illustration of a processor according to an embodiment. Processor 700 is an example of a type of hardware device that can be used in connection with the implementations above.

Processor 700 may be any type of processor, such as a microprocessor, an embedded processor, a digital signal processor (DSP), a network processor, a multi-core processor, a single core processor, or other device to execute code. Although only one processor 700 is illustrated in FIG. 7, a processing element may alternatively include more than one of processor 700 illustrated in FIG. 7. Processor 700 may be a single-threaded core or, for at least one embodiment, the processor 700 may be multi-threaded in that it may include more than one hardware thread context (or “logical processor”) per core.

FIG. 7 also illustrates a memory 702 coupled to processor 700 in accordance with an embodiment. Memory 702 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 700 can execute any type of instructions associated with algorithms, processes, or operations detailed herein. Generally, processor 700 can transform an element or an article (e.g., data) from one state or thing to another state or thing.

Code 704, which may be one or more instructions to be executed by processor 700, may be stored in memory 702, or may be stored in software, hardware, firmware, or any suitable combination thereof, or in any other internal or external component, device, element, or object where appropriate and based on particular needs. In one example, processor 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor 700 can also include execution logic 714 having a set of execution units 716a, 716b, 716n, etc. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor 700 allows out of order execution but requires in order retirement of instructions. Retirement logic 720 may take a variety of known forms (e.g., re-order buffers or the like). In this manner, processor 700 is transformed during execution of code 704, at least in terms of the output generated by the decoder, hardware registers and tables utilized by register renaming logic 710, and any registers (not shown) modified by execution logic 714.

Although not shown in FIG. 7, a processing element may include other elements on a chip with processor 700. For example, a processing element may include memory control logic along with processor 700. The processing element may include I/O control logic and/or may include I/O control logic integrated with memory control logic. The processing element may also include one or more caches. In some embodiments, non-volatile memory (such as flash memory or fuses) may also be included on the chip with processor 700.

Referring now to FIG. 8, a block diagram is illustrated of an example mobile device 800. Mobile device 800 is an example of a possible computing system (e.g., a host or endpoint device) of the examples and implementations described herein. In an embodiment, mobile device 800 operates as a transmitter and a receiver of wireless communications signals. Specifically, in one example, mobile device 800 may be capable of both transmitting and receiving cellular network voice and data mobile services. Mobile services include such functionality as full Internet access, downloadable and streaming video content, as well as voice telephone communications.

Mobile device 800 may correspond to a conventional wireless or cellular portable telephone, such as a handset that is capable of receiving “3G”, or “third generation” cellular services. In another example, mobile device 800 may be capable of transmitting and receiving “4G” mobile services as well, or any other mobile service.

Examples of devices that can correspond to mobile device 800 include cellular telephone handsets and smartphones, such as those capable of Internet access, email, and instant messaging communications, and portable video receiving and display devices, along with the capability of supporting telephone services. It is contemplated that those skilled in the art having reference to this specification will readily comprehend the nature of modern smartphones and telephone handset devices and systems suitable for implementation of the different aspects of this disclosure as described herein. As such, the architecture of mobile device 800 illustrated in FIG. 8 is presented at a relatively high level. Nevertheless, it is contemplated that modifications and alternatives to this architecture may be made and will be apparent to the reader, such modifications and alternatives contemplated to be within the scope of this description.

In an aspect of this disclosure, mobile device 800 includes a transceiver 802, which is connected to and in communication with an antenna. Transceiver 802 may be a radio frequency transceiver. Also, wireless signals may be transmitted and received via transceiver 802. Transceiver 802 may be constructed, for example, to include analog and digital radio frequency (RF) ‘front end’ functionality, circuitry for converting RF signals to a baseband frequency, via an intermediate frequency (IF) if desired, analog and digital filtering, and other conventional circuitry useful for carrying out wireless communications over modern cellular frequencies, for example, those suited for 3G or 4G communications. Transceiver 802 is connected to a processor 804, which may perform the bulk of the digital signal processing of signals to be communicated and signals received, at the baseband frequency. Processor 804 can provide a graphics interface to a display element 808, for the display of text, graphics, and video to a user, as well as an input element 510 for accepting inputs from users, such as a touchpad, keypad, roller mouse, and other examples. Processor 804 may include an embodiment such as shown and described with reference to processor 700 of FIG. 7.

In an aspect of this disclosure, processor 804 may be a processor that can execute any type of instructions to achieve the functionality and operations as detailed herein. Processor 804 may also be coupled to a memory element 806 for storing information and data used in operations performed using the processor 804. Additional details of an example processor 804 and memory element 806 are subsequently described herein. In an example embodiment, mobile device 800 may be designed with a system-on-a-chip (SoC) architecture, which integrates many or all components of the mobile device into a single chip, in at least some embodiments.

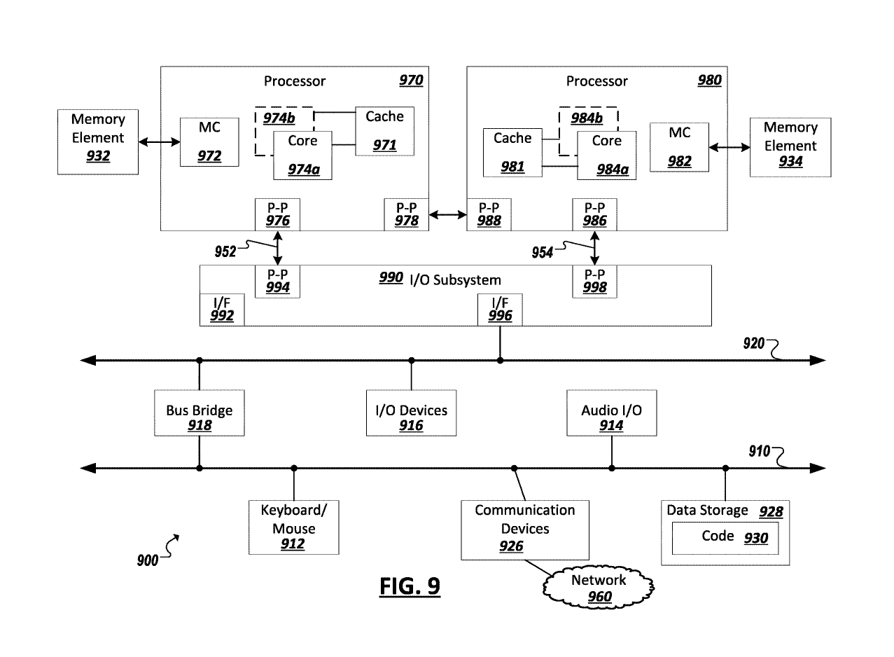

FIG. 9 is a schematic block diagram of a computing system 900 according to an embodiment. In particular, FIG. 9 shows a system where processors, memory, and input/output devices are interconnected by a number of point-to-point interfaces. Generally, one or more of the computing systems described herein may be configured in the same or similar manner as computing system 900.

Processors 970 and 980 may also each include integrated memory controller logic (MC) 972 and 982 to communicate with memory elements 932 and 934. In alternative embodiments, memory controller logic 972 and 982 may be discrete logic separate from processors 970 and 980. Memory elements 932 and/or 934 may store various data to be used by processors 970 and 980 in achieving operations and functionality outlined herein.

Processors 970 and 980 may be any type of processor, such as those discussed in connection with other figures. Processors 970 and 980 may exchange data via a point-to-point (PtP) interface 950 using point-to-point interface circuits 978 and 988, respectively. Processors 970 and 980 may each exchange data with a chipset 990 via individual point-to-point interfaces 952 and 954 using point-to-point interface circuits 976, 986, 994, and 998. Chipset 990 may also exchange data with a high-performance graphics circuit 938 via a high-performance graphics interface 939, using an interface circuit 992, which could be a PtP interface circuit. In alternative embodiments, any or all of the PtP links illustrated in FIG. 9 could be implemented as a multi-drop bus rather than a PtP link.

Chipset 990 may be in communication with a bus 920 via an interface circuit 996. Bus 920 may have one or more devices that communicate over it, such as a bus bridge 918 and I/O devices 916. Via a bus 910, bus bridge 918 may be in communication with other devices such as a keyboard/mouse 912 (or other input devices such as a touch screen, trackball, etc.), communication devices 926 (such as modems, network interface devices, or other types of communication devices that may communicate through a computer network 960), audio I/O devices 914, and/or a data storage device 928. Data storage device 928 may store code 930, which may be executed by processors 970 and/or 980. In alternative embodiments, any portions of the bus architectures could be implemented with one or more PtP links.

The computer system depicted in FIG. 9 is a schematic illustration of an embodiment of a computing system that may be utilized to implement various embodiments discussed herein. It will be appreciated that various components of the system depicted in FIG. 9 may be combined in a system-on-a-chip (SoC) architecture or in any other suitable configuration capable of achieving the functionality and features of examples and implementations provided herein.

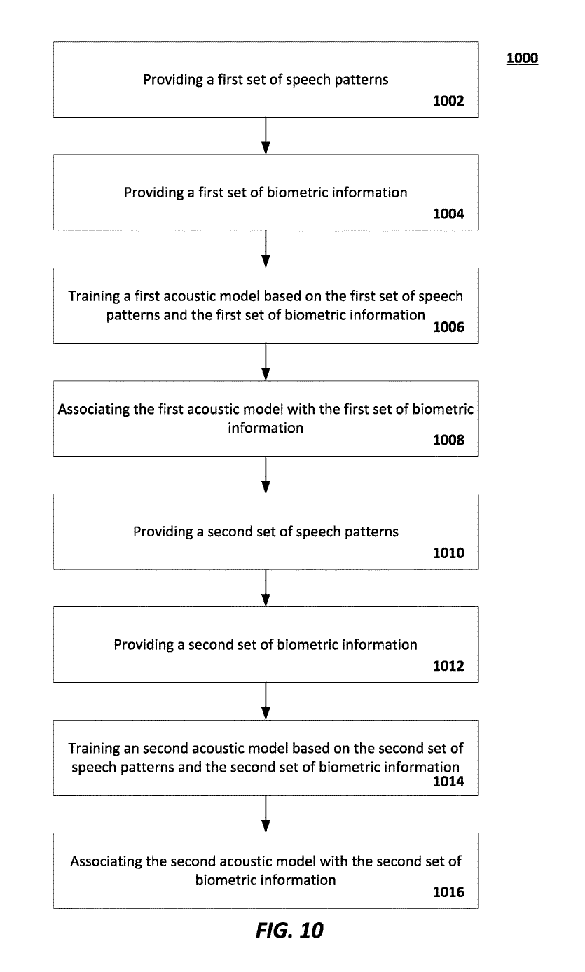

FIG. 10 is a process flow diagram 1000 for training an acoustic model for biometric input-based speech recognition. An adaptive ASR system training module can be provided a first set of speech patterns (1002). The training module can be provided a first set of biometric information (1004). The training module can train the a first acoustic model based on the first set of speech patterns and the first set of biometric information (1006). The training module can associate the first acoustic model with the first set of biometric information (1008). The adaptive ASR system training module can be provided a first set of speech patterns (1010). The training module can be provided a second set of biometric information (1012). The training module can train the a second acoustic model based on the second set of speech patterns and the second set of biometric information (1014). The training module can associate the second acoustic model with the second set of biometric information (1016).

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

Example 1 is an adaptive automatic speech recognition (ASR) device that includes a sound input to receive a speech input; a biometric input to receive a biometric signal; and an biometric processor in communication with the biometric input. The biometric processor to receive the biometric signal; identify a linguistic model based on the biometric signal; and a speech recognition modules to process the speech input for speech recognition using the identified linguistic model.

Example 2 may include the subject matter of example 1, wherein the linguistic model comprises one or both of an acoustic model or a language model.

Example 3 may include the subject matter of example 1 or 2, wherein the biometric signal comprises a signal representing a heartbeat.

Example 4 may include the subject matter of example 1 or 2 or 3, further comprising a biometric sensor in communication with the biometric input.

Example 5 may include the subject matter of example 1 or 2 or 3 or 4, further comprising a microphone in communication with the sound input.

Example 6 may include the subject matter of example 1 or 2 or 3 or 4 or 5, further comprising a biometric database to store biometric information associated with a user of the adaptive ASR device; and wherein the biometric processor is configured to compare the received biometric signal with a biometric information stored in the biometric database; and select the linguistic model based on the comparison of the received biometric signal and the stored biometric information.

Example 7 may include the subject matter of example 1 or 2 or 3 or 4 or 5 or 6, wherein the biometric signal indicates a context of the speech input and wherein the selected linguistic model compensates for the context of the speech input.

Example 8 may include the subject matter of example 1 or 2 or 3 or 4 or 5 or 6 or 7, further comprising a linguistic library, the linguistic library comprising a plurality of acoustic models, each acoustic model of the plurality of acoustic model associated with a biometric context.

Example 9 may include the subject matter of example 8, wherein the linguistic library comprises a plurality of language models, each language model of the plurality of language models associated with a biometric context.

Example 10 may include the subject matter of example 8 or 9, wherein the biometric context is based on a biometric input.

Example 11 is a method comprising receiving a speech signal; receiving a biometric signal from a biometric sensor implemented at least partially in hardware; determining a linguistic model based on the biometric signal; and processing the speech signal for speech recognition using the linguistic model based on the biometric signal.

Example 12 may include the subject matter of example 11, wherein the linguistic model comprises one or both of an acoustic model or a language model.

Example 13 may include the subject matter of example 11 or 12, further comprising comparing the received biometric signal with biometric information stored in the biometric database; and selecting the linguistic model based on the comparison of the received biometric signal and the stored biometric information.

Example 14 may include the subject matter of example 11 or 12 or 13, further comprising a selecting the linguistic model from a linguistic library, the linguistic library comprising a plurality of acoustic models, each acoustic model of the plurality of acoustic model associated with a biometric context, and a plurality of language models, each language model of the plurality of language models associated with a biometric context.

Example 15 is a system comprising an adaptive automatic speech recognition device comprising a sound input to receive a speech input; a biometric input to receive a biometric signal; an biometric processor in communication with the biometric input to receive the biometric signal; identify a linguistic model based on the biometric signal; and a speech recognition modules to process the speech input for speech recognition using the identified linguistic model. The system also includes a a dialog system comprising a parser module to convert the recognized speech into an instruction; and an intent classifier module to determine a command to execute on the system based on the instruction.

Example 16 may include the subject matter of example 15, wherein the linguistic model comprises one or both of an acoustic model or a language model.

Example 17 may include the subject matter of example 15 or 16, wherein the biometric signal comprises a signal representing a heartbeat.

Example 18 may include the subject matter of example 15 or 16 or 17, further comprising a biometric sensor in communication with the biometric input.

Example 19 may include the subject matter of example 15 or 16 or 17 or 18, further comprising a microphone in communication with the sound input.

Example 20 may include the subject matter of example 15 or 16 or 17 or 18 or 19, further comprising a biometric database to store biometric information associated with a user of the adaptive ASR device; and wherein the biometric processor is configured to compare the received biometric signal with a biometric information stored in the biometric database; and select the linguistic model based on the comparison of the received biometric signal and the stored biometric information.

Example 21 may include the subject matter of example 15 or 16 or 17 or 18 or 19 or 20, wherein the biometric signal indicates a context of the speech input and wherein the selected linguistic model compensates for the context of the speech input.

Example 22 may include the subject matter of example 15 or 16 or 17 or 18 or 19 or 20 or 21, further comprising a linguistic library, the linguistic library comprising a plurality of acoustic models, each acoustic model of the plurality of acoustic model associated with a biometric context.

Example 23 may include the subject matter of example 15 or 16 or 17 or 18 or 19 or 20 or 21 or 22, wherein the linguistic library comprises a plurality of language models, each language model of the plurality of language models associated with a biometric context.

Example 24 may include the subject matter of example 22 or 23, wherein the biometric context is based on a biometric input.

Example 25 may include the subject matter of example 15 or 16 or 17 or 18 or 19 or 20 or 21 or 22 or 23 or 24, wherein the dialog system is configured to select one or both of a parser module or an intent classifier module based on the biometric input.

While this specification contains many specific implementation details, these should not be construed as limitations on the scope of any disclosures or of what may be claimed, but rather as descriptions of features specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1-25. (canceled)

26. An adaptive automatic speech recognition (ASR) device comprising:
a sound input to receive a speech input;
a biometric input to receive a biometric signal;
an biometric processor in communication with the biometric input to:
receive the biometric signal;
identify a linguistic model based on the biometric signal; and
a speech recognition module to process the speech input for speech recognition using the identified linguistic model.

27. The adaptive ASR device of claim 26, wherein the linguistic model comprises one or both of an acoustic model or a language model.

28. The adaptive ASR device of claim 26, wherein the biometric signal comprises a signal representing a heartbeat.

29. The adaptive ASR device of claim 26, further comprising a biometric sensor in communication with the biometric input.

30. The adaptive ASR device of claim 26, further comprising a microphone in communication with the sound input.

31. The adaptive ASR device of claim 26, further comprising a biometric database to store biometric information associated with a user of the adaptive ASR device; and
wherein the biometric processor is configured to:
compare the received biometric signal with biometric information stored in the biometric database; and
select the linguistic model based on the comparison of the received biometric signal and the stored biometric information.

32. The adaptive ASR device of claim 26, wherein the biometric signal indicates a context of the speech input and wherein the selected linguistic model compensates for the context of the speech input.

33. The adaptive ASR device of claim 26, further comprising a linguistic library, the linguistic library comprising a plurality of acoustic models, each acoustic model of the plurality of acoustic model associated with a biometric context.

34. The adaptive ASR device of claim 33, wherein the linguistic library comprises a plurality of language models, each language model of the plurality of language models associated with a biometric context.

35. The adaptive ASR device of claim 33, wherein the biometric context is based on a biometric input.

36. A method comprising:
receiving a speech signal;
receiving a biometric signal from a biometric sensor implemented at least partially in hardware;
determining a linguistic model based on the biometric signal; and
processing the speech signal for speech recognition using the linguistic model based on the biometric signal.

37. The method of claim 36, wherein the linguistic model comprises one or both of an acoustic model or a language model.

38. The method of claim 36, further comprising:
comparing the received biometric signal with biometric information stored in the biometric database; and
selecting the linguistic model based on the comparison of the received biometric signal and the stored biometric information.

39. The method of claim 36, further comprising selecting the linguistic model from a linguistic library, the linguistic library comprising a plurality of acoustic models, each acoustic model of the plurality of acoustic model associated with a biometric context, and a plurality of language models, each language model of the plurality of language models associated with a biometric context.

40. A system comprising:
an adaptive automatic speech recognition device comprising:
a sound input to receive a speech input;
a biometric input to receive a biometric signal;
a biometric processor in communication with the biometric input to:
receive the biometric signal; ad
identify a linguistic model based on the biometric signal;
a speech recognition modules to:
process the speech input for speech recognition using the identified linguistic model; and
a dialog system comprising:
a parser module to convert the recognized speech into an instruction; and
an intent classifier module to determine a command to execute on the system based on the instruction.

41. The system of claim 40, wherein the linguistic model comprises one or both of an acoustic model or a language model.

42. The system of claim 40, further comprising a biometric database to store biometric information associated with a user of the adaptive ASR device; and wherein the biometric processor is configured to:
compare the received biometric signal with a biometric information stored in the biometric database; and
select the linguistic model based on the comparison of the received biometric signal and the stored biometric information.

43. The system of claim 40, wherein the biometric signal indicates a context of the speech input and wherein the selected linguistic model compensates for the context of the speech input.

44. The system of claim 40, further comprising a linguistic library, the linguistic library comprising a plurality of acoustic models, each acoustic model of the plurality of acoustic model associated with a biometric context;
wherein the linguistic library comprises a plurality of language models, each language model of the plurality of language models associated with a biometric context.

45. The system of claim 40, wherein the dialog system is configured to select one or both of a parser module or an intent classifier module based on the biometric input.
